(19) United States
(12) Patent Application Publication
(10) Pub. No.: US 2024/0070303 A1
(43) Pub. Date: Feb. 29, 2024

(54) File Encapsulation Validation

(71) Applicant: BULLWALL LAB A/S, Vejle Øst (DK)

(72) Inventors: Jan LOVMAND, Hedensted (DK); Lars TORP, Fredensborg (DK); Ivan MATEC, Bestovje (HR); Rasmus Bækgård HOLM, Vejle (DK)

(73) Assignee: BULLWALL LAB A/S, Vejle Øst (DK)

(21) Appl. No.: 18/550,295

(22) PCT Filed: Mar. 15, 2022
(86) PCT No.: PCT/EP2022/056622

§ 371 Date: Sep. 13, 2023

Related U.S. Application Data
(60) Provisional application No. 63/161,533, filed on Mar. 16, 2021.

(51) Int. Cl. G06F 21/62; G06F 21/31; G06F 21/60

(52) U.S. Cl. CPC G06F 21/6209; G06F 21/31; G06F 21/602

(57) ABSTRACT

The present invention provides a method for preventing illegitimate access to data, and in particular to prevent cybercriminals from exfiltrating readable data. A method is described for preventing illegitimate access to readable data in files (100), wherein said files (100) are continuously kept as encrypted files (100) while they are being stored (at rest) or transferred (in motion), and wherein access to the content of said files (100) by a user (120) comprises the steps:
When said user (120), from a dedicated computer device (140), clicks to open an encrypted file (100) from a specific data storage (90) monitored by a monitoring service (80), said file (100) is immediately transferred as an encrypted file (100) from the data storage (90) to a specified folder/directory on said user's computer device (140),
When the file (100) is located on said user's computer device (140), a validator agent (130) opens said file (100) and checks either
a) a unique file identifier (e.g., HASH, GUID or UUID) and said user's identity with at least the three factors of user credentials, computer device unique identifier and said user's access permissions relative to the protection level of said file (100), or
b) the type and origin location of said file (100), and said user's identity with at least three factors of user credentials, computer device unique identifier and said user's access permissions relative to the protection level of said file (100),
if the validator agent (130) confirms a) or b) the validator agent requests a decryption key from monitoring service (80), decrypts and opens said file (100) in the correct program as determined from the file, e.g., via file type extension and/or file metadata, without any additional clicks by the user (120),
if the validator agent (130) fails to confirm any of said checks a) and b) (or both of them), said file (100) is not decrypted and opened, and said user's access is denied and an alert signal is transmitted to monitoring service (80),
if said user (120) clicks to save said file (100), such as in a modified version, the validator agent (130) encrypts said file (100) and transfers and stores it in the origin location on the data storage (90).

### FIELD OF THE INVENTION

The invention relates to the field of data security and the safe storage and access to files in a data storage being e.g., a file share or cloud storage. The invention particularly relates to a method for preventing illegitimate access to readable data in files, and a program and a computer-readable medium with instructions for carrying out the method.

### BACKGROUND OF THE INVENTION

Attacks on digital systems and infrastructure takes many forms, some prominent types being viruses, malware, phishing and ransomware attacks. According to Cybersecurity Ventures, the cost of cybercrime is estimated to rise to $6 trillion by 2021, doubling it since 2015 and making it more lucrative than the trade of all illegal drugs combined. It is thus imperative for companies to protect their digital systems against such attacks. Ransomware attacks, by which hackers take company-critical data hostage against a cash pay-out, are especially dangerous. As companies are likely unable to operate without business-critical data, they face the terrible choice between paying the hackers for getting the data back—which may be illegal, and incentivizing future hackers; or trying to essentially start the company over—commonly spelling the doom for the company if it faces any kind of competition.

Ransomware attacks may be initiated by phishing, by which a system insider is fooled into granting the hacker access to the system by imitating insider behavior. Some companies thus train their employees in avoiding phishing. As it only takes one inattentive employee to fall for phishing to expose the whole organisation, this training of employees is a dangerous solution to rely solely on.

Organisations are seeing an increase in data exfiltration prior to the beginning of an encryption attack. This means that the cybercriminal copies out business-critical data, data including personal information and data containing trade secrets.

If cybercriminals succeed in getting access to a company's data this may not only paralyze company operations at large but it may also trigger significant direct costs such as fines for not complying with data regulations and direct ransom to the cybercriminals in return for them not to release critical data to competitors or to the public.

Thus, there is a need for preventing illegitimate access to readable data in files, and in particular to ensure that if cybercriminals manage to steal the data it will be unreadable to them.

### SUMMARY OF THE INVENTION

In a first aspect the present invention provides a method for preventing illegitimate access to readable data in files (100), wherein said files (100) are continuously kept as encrypted files (100) while they are being stored (at rest) or transferred (in motion), and wherein access to the content of said files (100) by a user (120) comprises the steps:
When said user (120), from a dedicated computer device (140), clicks to open an encrypted file (100) from a specific data storage (90) monitored by a monitoring service (80), said file (100) is immediately transferred as an encrypted file (100) from the data storage (90) to a specified folder/directory on said user's computer device (140),
When the file (100) is located on said user's computer device (140), a validator agent (130) opens said file (100) and checks either
a) a unique file identifier (e.g. HASH, GUID or UUID) and said user's identity with at least the three factors of user credentials, computer device unique identifier and said user's access permissions relative to the protection level of said file (100), or
b) the type and origin location of said file (100), and said user's identity with at least three factors of user credentials, computer device unique identifier and said user's access permissions relative to the protection level of said file (100),
if the validator agent (130) confirms a) or b) the validator agent requests a decryption key from monitoring service (80), decrypts and opens said file (100) in the correct program as determined from the file, e.g., via file type extension and/or file metadata, without any additional clicks by the user (120),
if the validator agent (130) fails to confirm any of said checks a) and b) (or both of them), said file (100) is not decrypted and opened, and said user's access is denied and an alert signal is transmitted to monitoring service (80),
if said user (120) clicks to save said file (100), such as in a modified version, the validator agent (130) encrypts said file (100) and transfers and stores it in the origin location on the data storage (90).

The method may serve to protect against illegitimate data access by individuals with no rights to read the contents, e.g., data exfiltration done by cybercriminals.

An advantage of the present invention is that confidential material is protected if documents are stolen and transferred to external parties outside an organization. This follows from files always being encrypted when at rest and in motion, e.g., on data storage devices, cloud storage or being transmitted. Also, internal threats from employees with full file access, e.g., curious IT department employees, are solved as they have access to the files, but not the necessary access level to be able to decrypt files and gain access to readable data.

Another advantage of the present invention is that no complicated data classification policies are required. Instead, the present invention can be enabled on certain data storages e.g., secret and classified storages, where access should be highly limited and the risk following breach of the data is business critical.

All users (120) work exactly like usual when opening and saving files and since the encrypted files may contain all required metadata including e.g., thumbnails (when available) when working in Explorer.

Hence the present invention provides a simple method which is not intrusive or complicated, but rather fast and easy to implement in computer systems. Hence, the present invention provides a significant layer of IT security with very little effort.

In a second aspect the present invention provides the use of the method described in the first aspect in combination with perimeter protection measures for providing cybersecurity of IT systems.

In a third aspect the present invention provides a computer device (140) having a processor (211) adapted to perform the steps of the method described in the first aspect.

In a fourth aspect the present invention provides a computer program comprising instructions which cause the computer device (140) to carry out the method as described in the first aspect, when the program is executed by a computer device (140).

In a fifth aspect the present invention provides a computer-readable medium comprising instructions which cause the computer device (140) to carry out the method described in the first aspect, when executed by a computer device (140).

### BRIEF DESCRIPTION OF THE FIGURES

FIG. 1. Schematic top-level illustration of the function of the method for preventing illegitimate access to readable data in files (100), where a user (120) clicks to open an encrypted file.

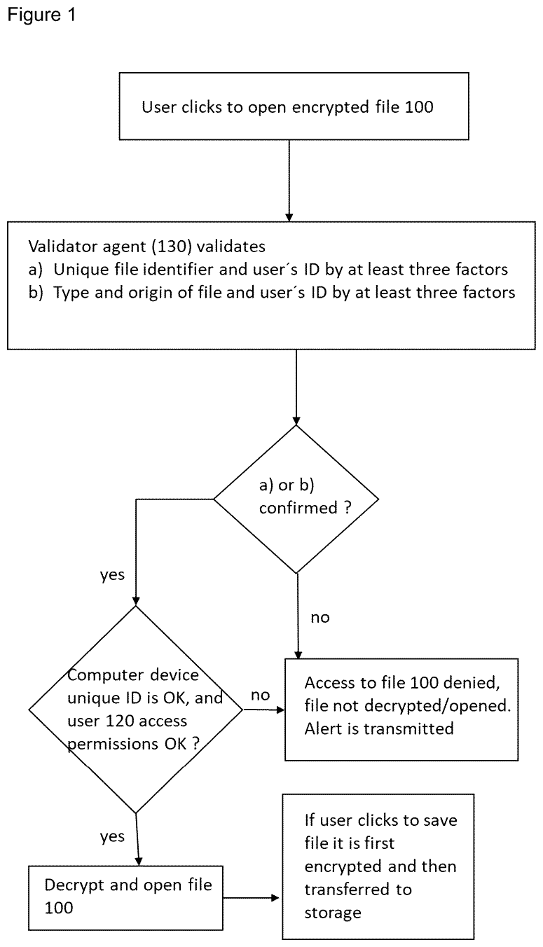

FIG. 2. Illustration of a computer device (140) accommodating the validator agent (130) algorithm, and algorithms for decryption/encryption upon keys therefor being received from computer device (145), according to an embodiment of the invention. The computer device (140) is assigned to a user and is in communication with monitoring computer device (145) and data storages (90).

FIG. 3. Illustration of a computer device (145) installed on e.g., a virtual server accommodating the monitoring service (80) algorithm, lists of user credentials, list of user protection levels, decryption/encryption keys, according to an embodiment of the invention. The computer device (145) is in communication with user computer devices (140) and data storages (90).

FIG. 4. Simplified scenario 1 where a user needs to access a file.

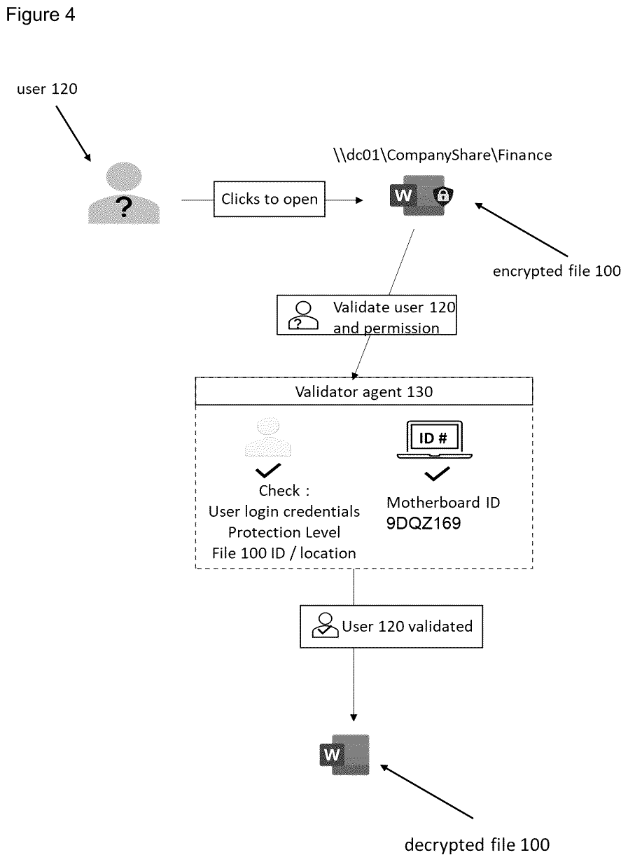

FIG. 5. Simplified scenario 2 where an illegitimate entity seeks to exfiltrate data from files.

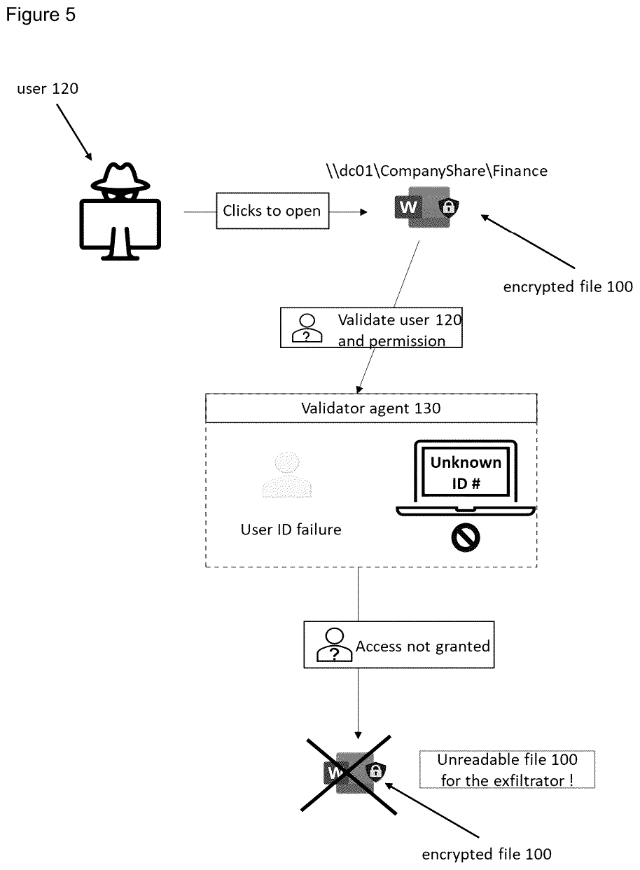

### DETAILED DESCRIPTION OF THE INVENTION

The present invention provides e.g. a method for preventing illegitimate access to readable data in files (100), wherein said files are continuously kept as encrypted files while they are being stored (at rest) or transferred (in motion), and wherein access to the content of said files by a user (120) comprises the steps:
When said user (120), from a dedicated computer device (140), clicks to open an encrypted file (100) from a specific data storage (90) monitored by a monitoring service (80), said file (100) is immediately transferred as an encrypted file (100) from the data storage (90) to a specified folder/directory on said user's computer device (140),
When the file (100) is located on said user's computer device (140), a validator agent (130) opens said file (100) and checks either
a) a unique file identifier (e.g., HASH, GUID or UUID) and said user's identity with at least the three factors of user credentials, computer device unique identifier and said user's access permissions relative to the protection level of said file (100), or
b) the type and origin location of said file (100), and said user's identity with at least three factors of user credentials, computer device unique identifier and said user's access permissions relative to the protection level of said file (100),
if the validator agent (130) confirms a) or b) the validator agent requests a decryption key from monitoring service (80), decrypts and opens said file (100) in the correct program as determined from the file, e.g., via file type extension and/or file metadata, without any additional clicks by the user (120),
if the validator agent (130) fails to confirm any of said checks a) and b) (or both of them), said file (100) is not decrypted and opened, and said user's access is denied and an alert signal is transmitted to monitoring service (80),
if said user (120) clicks to save said file (100), such as in a modified version, the validator agent (130) encrypts said file (100) and transfers and stores it in the origin location on the data storage (90).

By the term illegitimate access to readable data is meant access by unauthorized external users, such as hackers and other cybercriminals, but also internal users seeking to access readable data for which they do not been granted the access permission rights. Only decrypted files (100) are readable as the encrypted files present on the data storage (90) and being transmitted to a user's computer device (140) does not have the contents of the file as readable data until decryption is authorized and initiated by the validator agent (130).

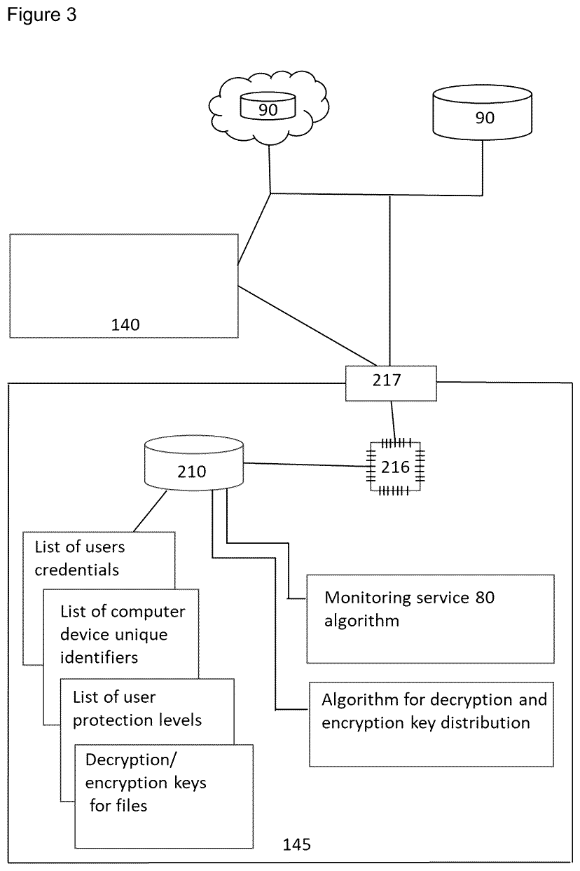

The monitoring service (80) is installed and runs on a virtual computer/server (e.g. Hypervisor) in e.g. a company's IT infrastructure surveying individual file shares and data storages (90). The monitoring service (80) also holds the list of e.g., decryption keys for all the encrypted files on the data storage(s) (90), and the list of access rights of all users to files (100), c.f. FIG. 3. If new unencrypted files are added or moved to a specific directory in the data storage (90), the monitoring service (80) will encrypt said new files based on the encryption level of said directory.

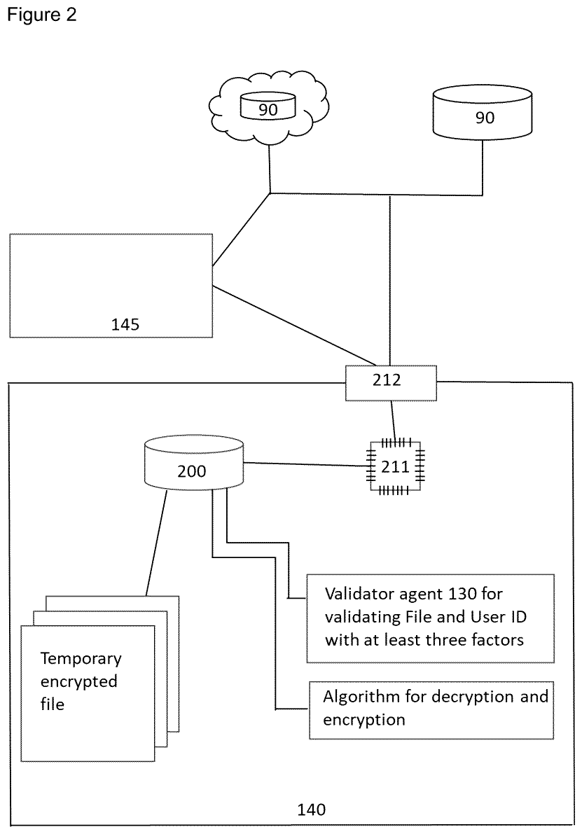

It is to be understood that the validator agent (130) is software residing and being executed on the user's computer device (140), c.f. FIG. 2. The validator agent (130) is in contact with the monitoring service (80) during e.g., the process of the checks a) and b), such as when determining a specific user's access permissions to a file (100). The validator agent (130) checks the user's identity with at least three factors being user credentials, computer device unique identifiers and user access permissions in relation to a specific file (100). These will be explained in some depth below.

User credentials typically comprise a username and a password, also referred to as a login. Fingerprint, retina scans or facial recognition may also be used as part of user credentials. Other factors such as e-mail confirmation or sms confirmation may also be used under some circumstances for additional security.

The computer device unique identifiers are used for identifying the computer device from which the user (120) requests access to a file (100). In this way illegitimate users may be identified because they are operating from a computer device (140) which is not registered or known to be used by an authorized user.

In one embodiment said computer device unique identifier is a motherboard ID, a browser identity code, a software identity code, a hardware serial or identification number of e.g., CPU, harddrive or motherboard, a combination thereof or a code calculated from a combination thereof. In a specific embodiment said computer device unique identifier is a motherboard ID.

In a further embodiment of the method of the invention, the checks a) and b) validates said user's identity by confirming that both the user credentials and the BIOS serial number matches. For instance, if user “Y” is known to work from a computer device having motherboard ID XU7HKA8, and user “X” is known to work from a computer device with motherboard ID 9DQZ169, the method of the present invention will raise an alert for additional verification and/or transmit an alert signal to the monitoring service (80) if an encrypted file is suddenly requested from a unverified user working on a computer device with unknown motherboard ID 297HDKJ798DB which is not registered or known to be associated with any user.

It is also the validator agent (130) which checks that the user access permissions match the specific file (100) for which the user (120) requests access.

In a further embodiment of the method of the invention, said validator agent's checks a) and b) validates said user's access permissions relative to the protection level of said file (100) according to a protection level directory.

In a yet further embodiment of the method of the invention, said validator agent (130) for the execution of the check of a) or b) transmits the user's credentials to said monitoring service (80) which responds with said user's access permissions relative to the protection level of said file (100). This permits the validator agent (80) to decide whether the user (120) is authorized to access that contents of the said file (100).

It is to be understood that the files (100) are only in a decrypted state on a user's computer device (140) following the validator agent's confirmation of a) or b), and until said files (100) are once again encrypted and subsequently transferred to the origin location on the data storage (80).

An encrypted file (100) will have it main contents in an encrypted form which is not readable so as to enable a reader to understand the content prior to decrypting the file. However, it is useful for an encrypted file (100) to have some contents which is not encrypted, such as for identification and storage purposes.

In an embodiment of the method of the invention, said encrypted files (100) thus contain some readable data, e.g., file metadata and/or file thumbnail.

The method of the present invention for preventing illegitimate access to readable data in files (100), may advantageously be used in company IT systems in addition to other IT and cyber security systems.

Hence, in an aspect of the invention the method for preventing illegitimate access to readable data in files (100) is used in combination with cyber security measures such as Intrusion Detection Systems (IDS), Data Loss Prevention (DLP), AV, gateways, firewalls and e-mail scanners.

In a further aspect the present invention also provides one or more computer devices (140) (145) having processors (211) (216) adapted to perform the steps of the method according to the first aspect.

In the practical implementation of the present method, a computer device (140) assigned to a user (120) will typically have a processor (211) adapted to perform the steps performed by the validator agent (130) while another computer device (145) in the central IT infrastructure has a processor (216) adapted to perform the steps performed by the monitoring service (80). The computer device (145) typically is a server whereas the computer device (140) is a laptop. This is illustrated in FIGS. 2 and 3.

In a further aspect the present invention provides a computer device (140) having a processor (211) adapted to perform the validator agent's (130) steps of the method as defined in the first aspect.

In a further aspect the present invention provides a computer device (145) having a processor (216) adapted to perform the monitoring service (80) steps of the method as defined in the first aspect.

In a yet further aspect, the present invention provides a computer program comprising instructions which cause the computer device (140) to carry out the validator agent's (130) steps of the method according to the first aspect, when the program is executed by a computer device (140).

In a yet further aspect, the present invention provides a computer program comprising instructions which cause a computer device (145) to carry out the monitoring service (80) steps of the method according to the first aspect, when the program is running on a computer device (145).

One such computer program implements the monitoring service (80), typically on a central server, while another computer program implements the validator agent (130), typically on end user's computer devices such as laptop computers, smartphones etc.

In a yet further aspect, the present invention provides a computer-readable medium comprising instructions which cause the computer device (140) to carry out the validator agent's (130) steps of the method according to the first aspect of the invention, when executed by a computer device (s140).

In a yet further aspect, the present invention provides a computer-readable medium comprising instructions which cause the computer device (145) to carry out the monitoring service (80) steps of the method according to the first aspect of the invention, when executed by a computer device (145).

1. A method for preventing illegitimate access to readable data in files, wherein said files are continuously kept as encrypted files while they are being stored (at rest) or transferred (in motion), and wherein access to the content of said files by a user (120) comprises the steps:
when said user, from a dedicated computer device, clicks to open an encrypted file from a specific data storage monitored by a monitoring service, said file is immediately transferred as an encrypted file from the data storage a specified folder/directory on said user's computer device,
when the file is located on said user's computer device, a validator agent opens said file and checks either
a) a unique file identifier (e.g., HASH, GUID or UUID) and said user's identity with at least the three factors of user credentials, computer device unique identifier and said user's access permissions relative to the protection level of said file, or
b) the type and origin location of said file, and said user's identity with at least three factors of user credentials, computer device unique identifier and said user's access permissions relative to the protection level of said file,
if the validator agent confirms a) or b) the validator agent requests a decryption key from monitoring service, decrypts and opens said file in the correct program as determined from the file, e.g., via file type extension and/or file metadata, without any additional clicks by the user,
if the validator agent fails to confirm any of said checks a) and b) (or both of them), said file is not decrypted and opened, and said user's access is denied and an alert signal is transmitted to monitoring service,
if said user clicks to save said file, such as in a modified version, the validator agent encrypts said file and transfers and stores it in the origin location on the data storage.

2. The method according to claim 1, wherein said computer device unique identifier is a motherboard ID, a browser identity code, a software identity code, a hardware serial or identification number of e.g., CPU, harddrive or motherboard, a combination thereof or a code calculated from a combination thereof.

3. The method according to claim 1, wherein the checks a) and b) validates said user's identity by confirming that both the user credentials and the motherboard ID matches.

4. The method according to claim 1, wherein said validator agent's checks a) and b) validates said user's access permissions relative to the protection level of said file according to a protection level directory.

5. The method according to claim 1, wherein said validator agent for the execution of the check of a) or b) transmits the user's credentials to said monitoring service which responds with said user's access permissions relative to the protection level of said file.

6. The method according to claim 1, wherein said files are only in a decrypted state on said user's computer device following said validator agent's confirmation of a) or b), and until said files are once again encrypted and subsequently transferred to the origin location on the data storage.

7. The method according to claim 1, wherein said encrypted files contain some readable file data, such as metadata and file thumbnail where these exist.

8. Use of the method as defined in claim 1 in combination with cyber security measures such as Intrusion Detection Systems (IDS), Data Loss Prevention (DLP), AV, gateways, firewalls and e-mail scanners.

9. A computer device having a processor adapted to perform the validator agent's steps of the method as defined in claim 1.

10. A computer program comprising instructions which cause the computer device to carry out the validator agents steps of the method as defined in claim 1, when the program is executed by a computer device.

11. A computer-readable medium comprising instructions which cause the computer device to carry out the validator agent's steps of the method as defined in claim 1, when executed by a computer device.

12. A computer device having a processor adapted to perform the monitoring service steps of the method as defined in claim 1.

13. A computer program comprising instructions which cause the computer device to carry out the monitoring service's steps of the method as defined in claim 1, when the program is executed by a computer device.

14. A computer-readable medium comprising instructions which cause the computer device to carry out the monitoring service steps of the method as defined in claim 1, when executed by a computer device.
